(19) United States
(12) Patent Application Publication
(10) Pub. No.: US 2016/0371791 A1
(43) Pub. Date: Dec. 22, 2016

(54) SOCIAL MEDIA BASED RECOMMENDATION INFORMATION PROVIDING APPARATUS AND METHOD

(71) Applicant: LINE Corporation, Tokyo (JP)

(72) Inventor: Il Gu Lee, Tokyo (JP)

(73) Assignee: LINE Corporation, Tokyo (JP)

(21) Appl. No.: 15/176,647

(22) Filed: Jun. 8, 2016

(30) Foreign Application Priority Data
Jun. 18, 2015 (KR) 10-2015-0086868

(51) Int. Cl. G06Q 50/00; G06F 17/30; H04L 29/08; H04L 12/58; H04L 29/06

(52) U.S. Cl. CPC G06Q 50/01; H04L 51/04; H04L 51/32; H04L 63/1483; H04L 67/306; G06F 17/30864

(57) ABSTRACT

A social media based recommendation information providing apparatus including a memory storing computer-readable instructions, and one or more processors configured to execute the computer-readable instructions such that the one or more processors are configured to acquire chat pattern information based on an interaction history of interaction between users, search for pieces of corresponding information corresponding to a message of one of the users from among pieces of function control information of user terminals and the chat pattern information, and provide other of the users with at least one piece of recommendation information from among the pieces of corresponding information may be provided.

### CROSS-REFERENCE TO RELATED APPLICATION

This application claims under 35 U.S.C. §119 priority to Korean Patent Application No. 10-2015-0086868, filed on Jun. 18, 2015, in the Korean Intellectual Property Office, the disclosure of which is incorporated herein in its entirety by reference.

### BACKGROUND

1. Field

The present disclosure relates to a social media based recommendation information providing apparatus and/or method, and more particularly, to a social media based recommendation information providing apparatus and/or method which provide a user with recommendation information corresponding to messages transmitted and received via messenger.

2. Description of the Related Art

With the rapid development of communication networks such as the Internet, users widely use social media to chat with one another or share information with one another through desktop computers, notebook computers, smart phones, or the like, which is connected to the communication network. That is, an Internet user may use the Internet to conveniently chat with other Internet users or share information with other Internet users anytime and anywhere. Such social media has brought many changes to people lives. As mobile communications have developed, social media has been used as a popular tool for communication or information sharing beyond national boundaries. The number of social media users is gradually increasing and the amount of social media based services are also gradually increasing.

Information disclosed in this Background section was already known to the inventors before achieving the inventive concepts or is technical information acquired in the process of achieving the inventive concepts. Therefore, it may contain information that does not qualify as prior art already known to the public.

### SUMMARY

Provided are social media based recommendation information providing apparatuses and methods which provide a user with recommendation information corresponding to messages transmitted and received via messenger.

Provided are social media based recommendation information providing apparatuses and methods which allow a user to more easily control functions of a user terminal by providing a user with recommendation information corresponding to messages transmitted and received via messenger.

Additional aspects will be set forth in part in the description which follows and, in part, will be apparent from the description, or may be learned by practice of the presented example embodiments.

According to an aspect of an example embodiment, a social media based recommendation information providing method may include acquiring, by at least one processor, chat pattern information based on an interaction history of interaction between users, searching for, by the at least one processor, pieces of corresponding information corresponding to a message of one of the users from among pieces of function control information of user terminals and the chat pattern information, and providing, by the at least one processor, other of the users with at least one piece of recommendation information from among the pieces of corresponding information

According to an aspect of another example embodiment, a social media based recommendation information providing apparatus may include a memory storing computer-readable instructions, and one or more processors configured to execute the computer-readable instructions such that the one or more processors are configured to acquire chat pattern information based on an interaction history of interaction between users, search for pieces of corresponding information corresponding to a message of one of the users from among pieces of function control information of user terminals and the chat pattern information, and provide other of the users with at least one piece of recommendation information from among the pieces of corresponding information

According to an aspect of another example embodiment, a non-transitory computer-readable recording medium storing a computer program, which when executed by a computer, configures the computer to perform the aforementioned method may be provided.

According to an aspect of another example embodiment, a distribution server configured to distribute a program for performing the aforementioned method on a computer may be provided.

Other aspects, features, advantages will become apparent from the accompanying drawing, claims, and detailed descriptions of example embodiments.

### BRIEF DESCRIPTION OF THE DRAWINGS

These and/or other aspects will become apparent and more readily appreciated from the following description of the example embodiments, taken in conjunction with the accompanying drawings in which:

FIG. 1 is a configuration diagram of a social media based recommendation information providing system according to an example embodiment;

FIG. 2 is a block diagram of a social media based recommendation information providing apparatus illustrated in FIG. 1;

FIG. 3 is a flowchart of a social media based recommendation information providing method according to an example embodiment;

FIG. 4 is a diagram for describing a method of classifying users into groups, according to an example embodiment;

FIG. 5 illustrates an example of a screen of a user terminal illustrated in FIG. 1, on which an instant messaging application is executed;

FIG. 6 illustrates another example of a screen of the user terminal illustrated in FIG. 1, on which the instant messaging application is executed; and

FIG. 7 illustrates another example of a screen of the user terminal illustrated in FIG. 1, on which the instant messaging application is executed.

### DETAILED DESCRIPTION

Reference will now be made in detail to some example embodiments, examples of which are illustrated in the accompanying drawings, wherein like reference numerals refer to like elements throughout. In this regard, example embodiments may have different forms and should not be construed as being limited to the descriptions set forth herein. Accordingly, some example embodiments are merely described below, by referring to the figures, to explain aspects. It will be understood that although the terms “first”, “second”, etc. may be used herein to describe various components, these components should not be limited by these terms. These components are only used to distinguish one component from another. As used herein, the singular forms “a”, “an”, and “the” are intended to include the plural forms as well, unless the context clearly indicates otherwise. It will be further understood that the terms “comprise”, “include”, and/or “have” used herein specify the presence of stated features or components, but do not preclude the presence or addition of one or more other features or components. Sizes of elements in the drawings may be exaggerated for convenience of explanation. In other words, since sizes and thicknesses of components in the drawings are arbitrarily illustrated for convenience of explanation, the following example embodiments are not limited thereto.

As used herein, the term “and/or” includes any and all combinations of one or more of the associated listed items. Expressions such as “at least one of,” when preceding a list of elements, modify the entire list of elements and do not modify the individual elements of the list. Thus, for example, both “at least one of A, B, or C” and “A, B, and/or C” means either A, B, C or any combination thereof.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, some example embodiments will be described in detail with reference to the accompanying drawings. In the following description, the same reference numerals are used to refer to the same or equivalent elements, and redundant descriptions thereof will not be repeated.

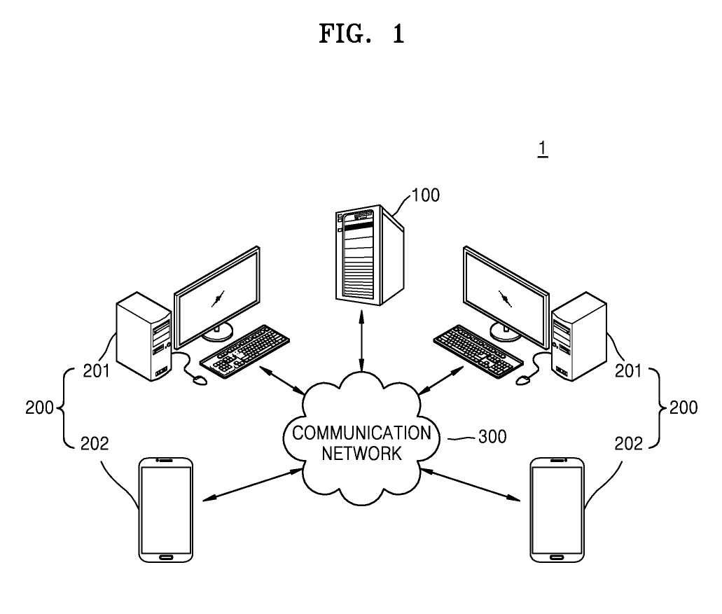

FIG. 1 is a configuration diagram of a social media based recommendation information providing system 1 according to an example embodiment.

Referring to FIG. 1, the social media based recommendation information providing system 1 according to the present example embodiment may include a social media based recommendation information providing apparatus 100 and a plurality of user terminals 200. The social media based recommendation information providing system 1 may further include a communication network 300 configured to mutually connect the plurality of user terminals 200 and the social media based recommendation information providing apparatus 100.

The social media based recommendation information providing apparatus 100 according to the present example embodiment may provide specific information to users through an instant messaging application installed on each of the user terminals 200. More specifically, the social media based recommendation information providing apparatus 100 may provide recommendation information together with a chat input window of the instant messaging application. When a user selects the recommendation information, the social media based recommendation information providing apparatus 100 may allow an input of content corresponding to the recommendation information, or may control a function of the user terminal 200 which corresponds to the recommendation information.

The social media based recommendation information providing apparatus 100 may provide a general search service and various services for increasing user convenience. That is, the social media based recommendation information providing apparatus 100 may be a server configured to provide various services, such as an advertisement service, a search service, an email service, a blogging service, a social media service, a news service, and a shopping information providing service.

The plurality of user terminals 200 may mean a communication terminal hat is capable of executing the instant messaging application in a wired or wireless communication environment. The plurality of user terminals 200 may be, for example, a personal computer 201 of a user, or may be a mobile terminal 202 of a user. The mobile terminal 202 is illustrated in FIG. 1 as a smart phone, but example embodiments are not limited thereto. Any terminals may be used as the mobile terminal 202 as long as the instant messaging application is installed thereon as described above.

The user terminals 200 may be, for example, computers (e.g., desktop computers, laptop computers, or tablet computers.), media computing platforms (e.g., cables, satellite set-tops, or digital video recorders), handheld computing devices (e.g., personal digital assistants (PDAs), or email clients), mobile phones, or computing or communication platforms, but are not limited thereto.

The communication network 300 may be configured to connect the plurality of user terminals 200 and the social media based recommendation information providing apparatus 100 to each other. The communication network 300 may mean a communication network that provides a connection path through which the user terminals 200 are connected to the social media based recommendation information providing apparatus 100 so as to transmit and receive data. Examples of the communication network 300 may include a wired network, such as local area networks (LANs), wide area networks (WANs), metropolitan area networks (MANs), or integrated service digital networks (ISDNs), and a wireless network, such as wireless LANs, code division multiple access (CDMA), Bluetooth, or satellite communications, However, the communication network 300 is not limited thereto.

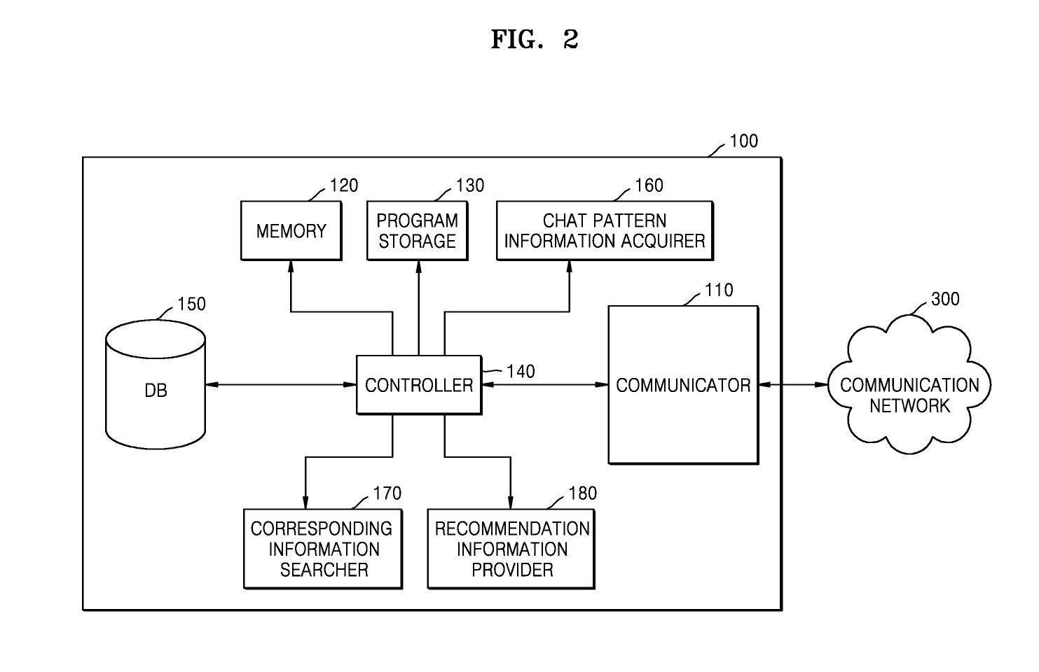

FIG. 2 is a block diagram of the social media based recommendation information providing apparatus 100 illustrated in FIG. 1.

Referring to FIG. 2, the social media based recommendation information providing apparatus 100 may include a communicator 110, a memory 120, a program storage 130, a controller 140, a database 150, a chat pattern information acquirer 160, a corresponding information searcher 170, and a recommendation information provider 180.

The communicator 110 may interoperate with the communication network 300 to provide a communication interface so that signals are transmitted and received between the social media based recommendation information providing apparatus 100 and the user terminals 200 in the form of packet data. Furthermore, the communicator 110 may be configured to transmit a message of a chat partner to the user terminal 200, or to provide recommendation information to the user terminal 200, and to receive a message from the user terminal 200.

The communicator 110 may be a device including hardware and software required for transmitting and receiving signals, such as control signals or data signals, via wired or wireless connection to other network devices.

The memory 120 may be configured to temporarily or permanently store data processed by the controller 140. The memory 120 may include magnetic storage media or flash storage media, but is not limited thereto.

The program storage 130 may be configured to store control software that performs an operation of collecting an interaction history from the user terminals 200, an operation of acquiring chat pattern information by using the interaction history, an operation of collecting pieces of function control information of the user terminals 200, an operation of searching for pieces of corresponding information corresponding to a message of one of users from among the pieces of function control information, an operation of determining recommendation information corresponding to the chat pattern information from among the pieces of corresponding information, or the like.

The controller 140 may be a type of a central processing unit (CPU) and may be configured to control an overall operation of collecting an interaction history from the user terminals 200, acquiring chat pattern information based on the interaction history, collecting pieces of function control information of the user terminals 200, searching for pieces of corresponding information corresponding to a message of one of users from among the pieces of function control information, determining recommendation information corresponding to the chat pattern information from among the pieces of corresponding information, and providing the recommendation information to the user terminals 200. That is, the controller 140 may provide various functions of driving the control software stored in the program storage 130, controlling the chat pattern information acquirer 160, the corresponding information searcher 170, and the recommendation information provider 180 to collect the interaction history from the user terminals 200, acquiring the chat pattern information by using the interaction history, collecting pieces of function control information of the user terminals 200, searching for pieces of corresponding information corresponding to a message of one of users from among the pieces of function control information, determining recommendation information corresponding to the chat pattern information from among the pieces of corresponding information, and providing the recommendation information to the user terminals 200.

The controller 140 may include any type of device capable of processing data like a processor. The term “processor” used herein may mean, for example, a data processor that is embedded in hardware and includes a circuit physically configured to perform functions expressed by codes or instructions included in a program. Examples of the data processor embedded in the hardware may include a microprocessor, a CPU, a processor core, a multiprocessor, an application-specific integrated circuit (ASIC), and a field programmable gate array (FPGA), but the data processor is not limited thereto.

The database 150 may include a template database configured to store information about the interaction history of interaction between the users, group information in which chat partners are classified, chat pattern information for each chat partner or group, function control information for each user terminal, information about a corresponding relationship between the function control information and the message, or the like.

The chat pattern information acquirer 160 may be configured to acquire the chat pattern information by using the interaction history of interaction between the users. For example, the chat pattern information acquirer 160 may acquire the chat pattern information between the users, based on a frequency of sending a “mock-anger reaction” message in response to a message such as “I'm sorry” between the user and the chat partner, and a frequency of sending a message such as “That's all right” in response to a message such as “I'm sorry”. In this case, the chat pattern information may include a parameter indicating that a degree of seriousness of a chat is “naughty” or “serious”. As another example, the chat pattern information acquirer 160 may be configured to acquire the chat pattern information between users, based on a time interval between messages. In this case, the chat pattern information may include a parameter indicating that the time interval between the messages is one of “short time”, “normal”, and “long time”. As another example, the chat pattern information acquirer 160 may be configured to acquire the chat pattern information between users, based on a ratio of a message of a user to messages between the users. In this case, the chat pattern information may include a parameter indicating that a chat leader is a “user” or a “partner”. As another example, the chat pattern information acquirer 160 may be configured to acquire the chat pattern information between users, based on a presence or absence of a message including financial transaction information, such as an amount of money, an account number, an account holder, among messages between the users. In this case, the chat pattern information may include a parameter indicating a “presence” or “absence” of a financial transaction relationship . As another example, the chat pattern information acquirer 160 may be configured to acquire the chat pattern information by using a length of a message, a type of an emoticon, a response speed, a ratio of the message to the emoticon, etc.

In some example embodiments, the chat pattern information acquirer 160 may be configured to classify the users into groups by using the interaction history and acquire the chat pattern information with respect to each of the groups. For example, the chat pattern information acquirer 160 may classify the users into different groups according to whether a frequency of use of emoticons included in the interaction history is equal to or greater than a desired (or preset) reference frequency. For example, the chat pattern information acquirer 160 may classify the users into different groups according to whether a time interval between messages included in the interaction history is equal to or greater than a desired (or preset) reference interval.

In some example embodiments, the chat pattern information acquirer 160 may be configured to acquire chat attributes between the users by using a K-means algorithm, a singular value decomposition (SVD) algorithm, an affinity propagation (AP) algorithm, or the like with respect to messages of the users, and acquire chat attributes of the users.

In some example embodiments, the chat pattern information acquirer 160 may be configured to classify the users into groups by using the interaction history. For example, when the chat pattern information acquirer 160 determines that a relationship between a user A and a user B is similar to a relationship between a user C and a user D, by using the interaction history, the chat pattern information acquirer 160 may classify a relationship between the user A and the user B and a relationship between the user C and the user D into the same group. The recommendation information provider 180 may provide the same recommendation information to the users having relationships classified into the same group.

The corresponding information searcher 170 may search for pieces of corresponding information corresponding to a message of one of the users from among the pieces of function control information of the user terminals and the chat pattern information. The pieces of function control information may include one or more selected from among user location information, message notification method setting information, phishing history information, user profile information, calendar information, photo album information, and web information.

In some example embodiments, when the corresponding information searcher 170 determines that the message of the one user is a message requesting a location of another user, the corresponding information searcher 170 may search for the user location information as the corresponding information. When a desired (or preset) location request word is included in the message of the one user, the corresponding information searcher 170 may determine that the corresponding message is a message requesting a location of another user. For example, in a message “where are you?” sent by the chat partner, the corresponding information searcher 170 may determine from the word “where” that the corresponding message is a message requesting a location of another user. The user location information may be an address indicating the location of the other user which is acquired by using a global positioning system (GPS) of the user terminal, or may be an image where the location of the other user is marked in a map application. For example, when the user is located at “Dogok-dong, Gangnam-gu”, the corresponding information searcher 170 may acquire information such as a rough address “Dogok-dong, Gangnam-gu” corresponding to the location of the user by using the GPS of the user terminal, a full address “13, 30-gil, Eonju-ro, Dogok-dong, Gangnam-gu, Seoul”, an image where the location of the other user is marked in the map application, or an image acquired by image-searching “Dogok-dong, Gangnam-gu” on a web, as the corresponding information.

In some example embodiments, when the message of the one user is successively input more than a desired (or preset) reference number of times in a desired (or preset) reference time, the corresponding information searcher 170 may search for the message notification method setting information as the corresponding information. For example, when the message of the one user is successively input more than once (an example reference number of times) in ten minutes (an example reference time), the corresponding information searcher 170 may search for the message notification method setting information as the corresponding information. The message notification method setting information may include a setting of turning off a message reception notification for a set period of time, such as “silent”, “1-hour notification off”, or “10-minute notification off”, may include a setting of increasing the number of message reception notifications, such as “increase in the number of notifications” or “infinite repetition of notification”, and may include a notification method setting capable of identifying a message of one of specific users, such as “notification color setting” or “notification sound setting”. The message notification method setting information may include a notification method setting, such as “notification word designation”, which is capable of receiving a notification only when a message including a word designated by a user is received. For example, in the case of a group chat window where a plurality of chat partners are included, a user may designate his or her name and nickname so that a notification is received only when the user is called.

In some example embodiments, when the corresponding information searcher 170 determines that a message the one user sent is a suspected to be a phishing message, the corresponding information searcher 170 may search for suspected phishing information as the corresponding information. When the message of the one user is sent to more than a desired (or preset) reference number of users in the same form, the corresponding information searcher 170 may determine that the corresponding message is a suspected phishing message. Also, when the message of the one user includes information about a deposit amount, a deposit account number, an account holder name, and the like and is sent to a plurality of users, the corresponding information searcher 170 may determine that the corresponding message is a suspected phishing message. The corresponding information searcher 170 may acquire a response message for identifying the chat partner as the suspected phishing message so as to prepare for a phishing attack. For example, the corresponding information searcher 170 may acquire a response message for identifying the chat partner, such as “Call me first”, “You are XX, right?”, “Which high school did you graduate from?”, or “Where did you say you lived?”, as the suspected phishing message.

In some example embodiments, when the corresponding information searcher 170 determines that the message of the one user is a message requesting user profile information, the corresponding information searcher 170 may search for the user profile information as the corresponding information. When a desired (or preset) profile request word is included in the message of the one user, the corresponding information searcher 170 may determine that the corresponding message is the message requesting the user profile information. For example, in a message “I have an article to be delivered for you. Please, let me know your home address” sent by the chat partner, the corresponding information searcher 170 may determine from the words “home address” that the corresponding message is a message requesting a user's address. The user profile information may include a phone number and an address that are stored as a contact that the user has designated as himself or herself in a contact application of the user terminal. For example, in a case where the user designated himself or herself as an “I” item in the contact application and stored address information such as “XXth floor, 13, 30-gil, Eonju-ro, Dogok-dong, Gangnam-gu, Seoul” in the “I” item, when the corresponding information searcher 170 determines that the message of the one user is a message requesting a user's address, the corresponding information searcher 170 may acquire “XXth floor, 13, 30-gil, Eonju-ro, Dogok-dong, Gangnam-gu, Seoul” stored in the “I” item as the corresponding information.

The recommendation information provider 180 may provide the user with at least one piece of recommendation information from among the pieces of corresponding information. For example, when the corresponding information is a setting such as “silent”, “1-hour notification off”, “10-minute notification off”, “increase in the number of notifications”, or “infinite repetition of notification”, contents having no relation to the user himself or herself are frequently transmitted and received in the group chat room, and the chat pattern information includes a parameter indicating that the time interval between messages is “short time”, the recommendation information provider 180 may provide the corresponding information such as “silent” and “1-hour notification off” as the recommendation information. In addition, when the corresponding information is a setting such as “silent”, “1-hour notification off”, “10-minute notification off”, “increase in the number of notifications”, or “infinite repetition of notification” and the chat pattern information includes a parameter indicating that the time interval between messages is “long time”, the recommendation information provider 180 may provide the corresponding information such as “increase in the number of notifications” or “infinite repetition of notification” as the recommendation information. In the case of a one-to-one chat room, when the chat pattern information includes a parameter indicating that the time interval between messages is “short time”, as opposed to the above case, a relationship between users may be a relationship requiring a quick response, the recommendation information provider 180 may provide the corresponding information such as “increase in the number of notifications” or “infinite repetition of notification” as the recommendation information.

As another example, when the chat pattern information includes a parameter indicating that the degree of seriousness of a chat with a specific partner is “naughty”, an emoticon or informal speech may be provided as the recommendation information at the time of chatting with the corresponding partner. When the chat pattern information includes a parameter indicating that the degree of seriousness of a chat with a specific partner is “serious”, honorific speech may be provided as the recommendation information. As another example, in a case where it is determined from the history of chatting with the partner that the user and the partner have come back from a specific travel site, if one of them inputs the words “travel photos” or a sentence “send me photos”, metadata of photos stored in the device of the partner may be searched for and a corresponding photo list may be provided as the recommendation information so that photos taken at the corresponding travel site may be attached and sent.

In some example embodiments, a social media based recommendation information providing apparatus 100 may include a memory storing computer-readable instructions; and one or more processors configured to execute the computer-readable instructions such that the one or more processors are configured to acquire chat pattern information based on an interaction history of interaction between users, search for pieces of corresponding information corresponding to a message of one of the users from among pieces of function control information of a user terminal and the chat pattern information, and provide the user with at least one piece of recommendation information from among the pieces of corresponding information

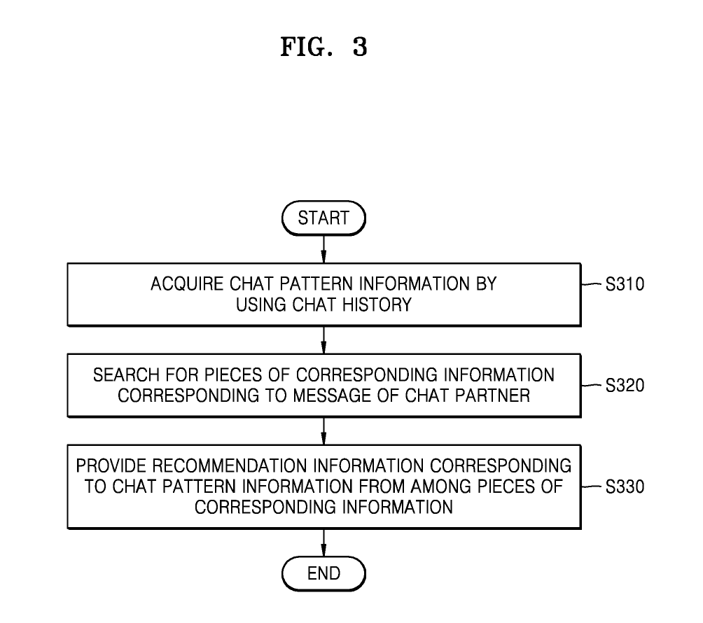

FIG. 3 is a flowchart of a social media based recommendation information providing method according to an embodiment.

Referring to FIG. 3, the social media based recommendation information providing method according to the present example embodiment may include: operation S310 of acquiring, by the chat pattern information acquirer 160, chat pattern information by using an interaction history; operation S320 of searching for, by the corresponding information searcher 170, pieces of corresponding information corresponding to a message of one of users; and operation S330 of providing, by the recommendation information provider 180, recommendation information corresponding to the chat pattern information from among the pieces of corresponding information.

In operation S310, the chat pattern information acquirer 160 may acquire the chat pattern information by using the interaction history of interaction between the users. In operation S310, the chat pattern information acquirer 160 may classify the users into groups by using the interaction history and acquire the chat pattern information with respect to each of the groups.

In operation S320, the corresponding information searcher 170 may search for pieces of corresponding information corresponding to a message of one of the users from among pieces of function control information of a user terminal. In operation S320, the pieces of function control information may include one or more selected from among user location information, message notification method setting information, phishing history information, user profile information, calendar information, photo album information, and web information, and/or the corresponding information searcher 170 may analyze a message of one of the users and search for one or more pieces of corresponding information from among the pieces of function control information.

In operation S330, the recommendation information provider 180 may provide the user with at least one piece of recommendation information from among the pieces of corresponding information.

According to some example embodiments, a social media based recommendation information providing method may include acquiring, by at least one processor, chat pattern information based on an interaction history of interaction between users, searching for, by the at least one processor, pieces of corresponding information corresponding to a message of one of the users from among pieces of function control information of a user terminal and the chat pattern information, and providing, by the at least one processor, the user with at least one piece of recommendation information from among the pieces of corresponding information.

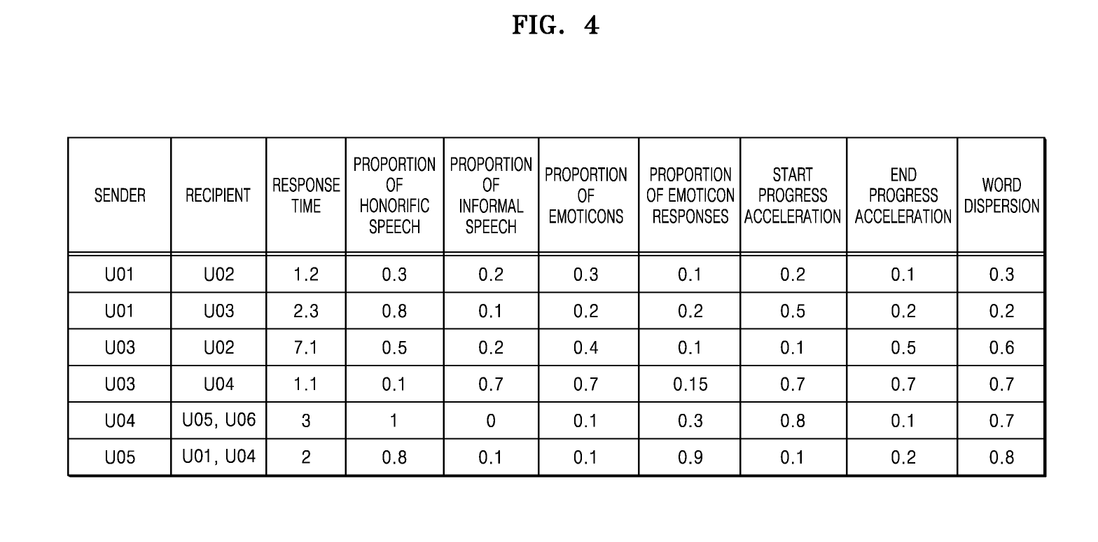

FIG. 4 is a diagram for describing a method of classifying users into groups, according to an example embodiment.

Referring to FIG. 4, the social media based recommendation information providing apparatus according to the present example embodiment may acquire chat pattern information including a response time, a proportion of honorific speech, a proportion of informal speech, a proportion of emoticons, a proportion of emoticon responses, a start progress acceleration, an end progress acceleration, and a word dispersion, by using the interaction history of interaction between the users. Values of the items included in the chat pattern information may be values having a unit, or may be relative values having no unit. Hereinafter, it is assumed that the values of the items are the relative values having no unit.

The response time is a time interval between messages that the users sent. A shorter response time may indicate a shorter time interval between the messages. For example, when a response time between a user U01 and a user U02 is 1.2 and a response time between the user U01 and a user U03 is 2.3, a time interval between messages that the user U01 and the user U02 sent may be shorter than a time interval between messages that the user U01 and the user U03 sent.

In the social media based recommendation information providing apparatus according to the present example embodiment, a parameter indicating that the time interval between the messages is one of “short time”, “normal”, and “long time” may be further included in the chat pattern information, based on a response time between specific users.

The proportion of honorific speech and the proportion of informal speech may be respectively a proportion of messages determined as the honorific speech and a proportion of messages determined as the informal speech from among the total messages that the users sent. For example, when the proportion of honorific speech between the user U01 and the user U02 is 0.3 and the proportion of informal speech between the user U01 and the user U02 is 0.2, the messages determined as the honorific speech may occupy a higher proportion than the messages determined as the informal speech, among the total messages that the user U01 and the user U02 sent.

The proportion of emoticons may be a ratio of emoticons to the total messages that the users sent. The proportion of emoticon responses may be a ratio of responses using emoticons to the total messages that the users sent.

In the social media based recommendation information providing apparatus according to the present example embodiment, a parameter indicating that the degree of seriousness of the chat is “naughty” or “serious” may be further included in the chat pattern information, based on, for example, the proportion of honorific speech, the proportion of informal speech, the proportion of emoticons, and the proportion of emoticon responses between specific users.

The start progress acceleration may be the number of sending messages in a unit time after a chat between users starts, and the end progress acceleration may be the number of sending messages in a unit time before the chat ends. When each of the users has sent a message in a desired (or preset) time at least once, it may be determined that the chat started at the time when the first message was sent, When a desired (or preset) time has elapsed from the sending of the last message, it may be determined that the chat ended at the time when the last message was sent.

The word dispersion is a relative value of dispersion with respect to the number of inputs of words or emoticons included in the total messages that the users have sent. As the word dispersion is lower, it may mean that the users do not frequently use the same word or emoticon, For example, when words or emoticons included in the total messages that the users have sent are not redundantly input, the number of inputs of the words or emoticons becomes 1, Therefore, the dispersion with respect to the words or emoticons may be zero. That is, when a dispersion of a chat between the user U01 and the user U02 is 0.3 and a dispersion of a chat between the user U01 and the user U03 is 0.2, it may mean that the same word or emoticon is more frequently used between the user U01 and the user U03 than between the user U01 and the user U02.

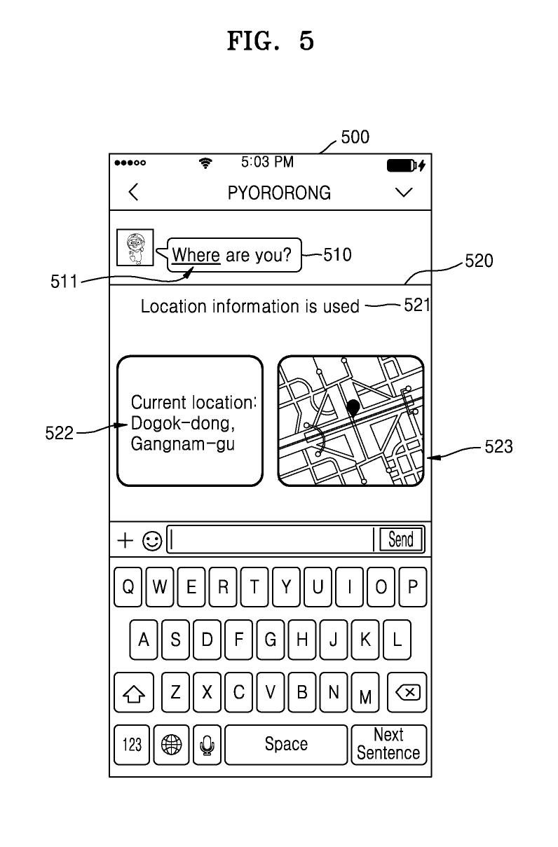

FIG. 5 illustrates an example of a screen 500 of the user terminal illustrated in FIG. 1, on which an instant messaging application is executed.

FIG. 5 illustrates the screen 500 on which recommendation information 520 corresponding to a message 510 of a chat partner. The screen 500 is provided by a terminal application that is executed on the user terminal.

For example, when the chat partner sent the message 510 such as “where are you?”, the social media based recommendation information providing apparatus according to the present example embodiment may determine that the corresponding message is a message requesting a user's location, based on a location request word 511 such as “where” in the message 510 of the chat partner, acquire an address such as “13, 30-gil, Eonju-ro, Dogok-dong, Gangnam-gu, Seoul” by using a GPS of the user terminal, a rough address 522 “Dogok-dong, Gangnam-gu” by using the user's location, and/or a map image where the user's location is marked, as the corresponding information, and provide the address 522 and the map image 523 as the recommendation information 520.

The social media based recommendation information providing apparatus according to the present example embodiment may provide a notification message 521, such as “Location information is used”, together with the recommendation information 520 so as to notify to the user that the GPS of the user terminal is used.

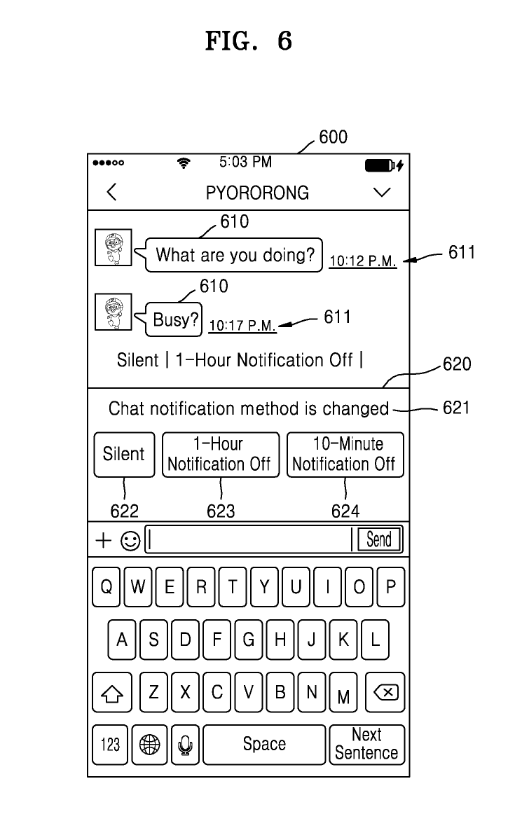

FIG. 6 illustrates another example of a screen 600 of the user terminal illustrated in FIG. 1, on which an instant messaging application is executed.

FIG. 6 illustrates the screen 600 on which recommendation information 620 corresponding to messages 610 of a chat partner. The screen 600 is provided by a terminal application that is executed on the user terminal.

For example, when the desired (or preset) reference time is 10 minutes, the desired (or preset) reference number of times is one time, and the chat partner sent the messages 610 at 10:12 p.m. and 10:17 pm., the social media based recommendation information providing apparatus according to the present example embodiment may determine that the messages 610 of the chat partner have been successively input more than the desired (or) reference number of times in the desired (or preset) reference time, acquire message notification method setting information, such as “silent” 622, “1-hour notification off” 623, or “10-minute notification off”, as corresponding information, and provide the message notification method setting information as the recommendation information 620.

The social media based recommendation information providing apparatus according to the present example embodiment may provide a notification message 621, such as “Chat Notification method is changed”, together with the recommendation information 620 so as to notify to the user that the notification method of the user terminal is changed.

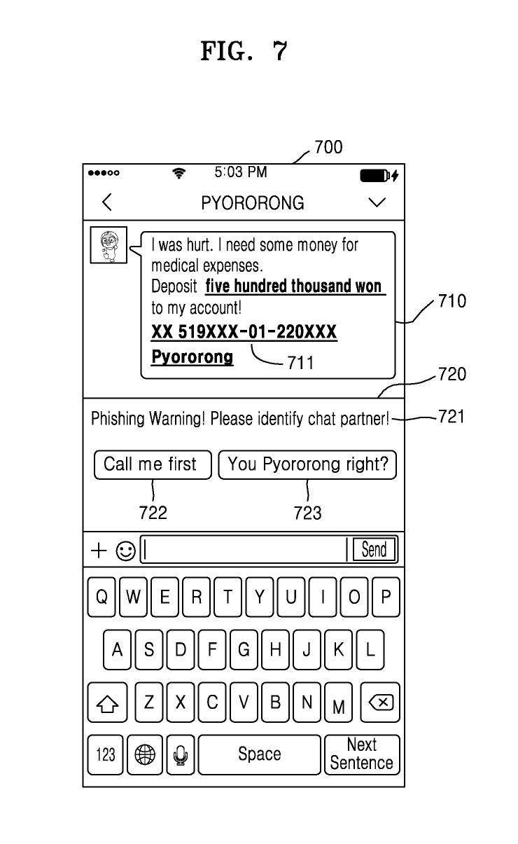

FIG. 7 illustrates another example of a screen 700 of the user terminal illustrated in FIG. 1, on which an instant messaging application is executed.

FIG. 7 illustrates the screen 700 on which recommendation information 720 corresponding to messages 710 of a chat partner is provided by a terminal application that is executed on the user terminal.

For example, when a desired (or preset) reference number of persons is ten and the messages 710 of the chat partner include information 711 such as deposit amount, a deposit account, or an account holder name and are sent to ten or more users, the social media based recommendation information providing apparatus according to the present example embodiment may determine that the messages 710 of the chat partner are suspected phishing messages, acquire a response message for identifying the chat partner, such as “Call me first” 722 and/or “You Pyororong, right?” 723, as the suspected phishing message, and provide the response message as the recommendation information 720.

The social media based recommendation information providing apparatus according to the present example embodiment may provide a notification message 721, such as “Phishing warning! Please, identify a chat partner!”, together with the recommendation information 720 so as to warn the user against phishing.

According to embodiments, the social media based recommendation information providing apparatuses and methods are capable of providing a user with recommendation information corresponding to messages transmitted and received via messenger.

Further, the social media based recommendation information providing apparatuses and/or methods allow a user to more easily control functions of a user terminal by providing a user with recommendation information corresponding to messages transmitted and received via, for example, a messenger application.

Units and/or devices according to one or more example embodiments may be implemented using hardware and/or a combination hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

The example embodiments set forth herein may be embodied as program instructions that can be executed by various computing units and recorded on a non-transitory computer-readable recording medium. Examples of the non-transitory computer-readable recording medium may include program instructions, data files, and data structures solely or in combination. The program instructions recorded on the non-transitory computer-readable recording medium may be specifically designed and configured for the inventive concepts, or may be well known to and usable by those of ordinary skill in the field of computer software. Examples of the non-transitory computer-readable recording medium may include magnetic media (e.g., a hard disk, a floppy disk, a magnetic tape, etc.), optical media (e.g., compact disc-read-only memory (CD-ROM), digital versatile disk (DVD), etc.), magneto-optical media (e.g., a floptical disk, etc.), and a hardware device specially configured to store and execute program instructions (e.g.; ROM, random access memory (RAM), flash memory, etc.). The non-transitory computer-readable recording medium may include an intangible medium that is implemented to be transmittable on a network. For example, the non-transitory computer-readable recording medium may be implemented by software or applications that are transmittable and distributable via a network (e.g., Internet).

The particular implementations shown and described herein are illustrative examples of the disclosure and are not intended to otherwise limit the scope of the disclosure in any way. For the sake of brevity, conventional electronics, control systems, software, and other functional aspects of the systems may not be described in detail. Furthermore, the connecting lines or connecting members shown in the various figures are intended to represent functional relationships and/or physical or logical connections between the various elements. It should be noted that many alternative or additional functional relationships, physical connections or logical connections may be present in a practical apparatus. Moreover, no component is essential to the practice of the embodiments unless the element is specifically described as “essential” or “critical”.

It should be understood that the example embodiments described herein should be considered in a descriptive sense only and not for purposes of limitation. Descriptions of features or aspects within each example embodiment should typically be considered as available for other similar features or aspects in other example embodiments.

While some example embodiments have been described with reference to the figures, it will be understood by those of ordinary skill in the art that various changes in form and details may be made therein without departing from the spirit and scope as defined by the following claims.

What is claimed is:

1. A social media based recommendation information providing method comprising:
acquiring, by at least one processor, chat pattern information based on an interaction history of interaction between users;
searching for, by the at least one processor, pieces of corresponding information corresponding to a message of one of the users from among pieces of function control information of user terminals and the chat pattern information; and providing, by the at least one processor, other of the users with at least one piece of recommendation information from among the pieces of corresponding information.

2. The social media based recommendation information providing method of claim 1, wherein the acquiring comprises:
classifying, by the at least one processor, the users into groups based on the interaction history; and
acquiring the chat pattern information with respect to each of the groups.

3. The social media based recommendation information providing method of claim 2, wherein the acquiring comprises:
classifying, by the at least one processor, the users into different groups according to whether a frequency of use of emoticons included in the interaction history is equal to or greater than a reference frequency.

4. The social media based recommendation information providing method of claim 1, wherein the acquiring comprises classifying, by the at least one processor, the users into different groups according to whether a time interval between messages included in the interaction history is equal to or greater than a reference interval.

5. The social media based recommendation information providing method of claim 1, wherein the pieces of function control information comprise one or more selected from among user location information, message notification method setting information, phishing history information, user profile information, calendar information, photo album information, and web information.

6. The social media based recommendation information providing method of claim 5, wherein the searching comprises:
determining, by the at least one processor, whether a location request word is included in the message of the one of the users; and
searching, by the at least one processor, for the user location information as the corresponding information when the at least one processor determines that the location request word is included.

7. The social media based recommendation information providing method of claim 5, wherein the searching comprises:
determining, by the at least one processor, whether the message of the one of the users is successively input more than a reference number of times in a reference time; and
searching for the message notification method setting information as the corresponding information when the at least one processor determines that the message of the one user is successively input more than the reference number of times in the reference time.

8. The social media based recommendation information providing method of claim 5, wherein the searching comprises:
determining, by the at least one processor, whether a same message as the message of the one of the users has been sent to more than a reference number of users; and
searching, by the at least one processor, for the phishing history information as the corresponding information when the at least one processor determines that the same message as the message of the one of the users is sent to more than the reference number of users.

9. The social media based recommendation information providing method of claim 5, wherein the searching comprises:
determining, by the at least one processor, whether a desired profile request word is included in the message of the one of the users; and
searching, by the at least one processor, for the user profile information as the corresponding information when the at least one processor determines that the profile request word is included.

10. A social media based recommendation information providing apparatus comprising:
a memory storing computer-readable instructions; and
one or more processors configured to execute the computer-readable instructions such that the one or more processors are configured to,
acquire chat pattern information based on an interaction history of interaction between users,
search for pieces of corresponding information corresponding to a message of one of the users from among pieces of function control information of user terminals and the chat pattern information, and
provide other of the users with at least one piece of recommendation information from among the pieces of corresponding information.

11. The social media based recommendation information providing apparatus of claim 10, wherein the one or more processors are further configured to:
classify the users into groups based on the interaction history; and
acquire the chat pattern information with respect to each of the groups.

12. The social media based recommendation information providing apparatus of claim 11, wherein the one or more processors are further configured to classify the users into different groups according to whether a frequency of use of emoticons included in the interaction history is equal to or greater than a reference frequency.

13. The social media based recommendation information providing apparatus of claim 11, wherein the one or more processors are further configured to classify the users into different groups according to whether a time interval between messages included in the interaction history is equal to or greater than a reference interval.

14. The social media based recommendation information providing apparatus of claim 10, wherein the pieces of function control information comprise one or more selected from among user location information, message notification method setting information, phishing history information, user profile information, calendar information, photo album information, and web information.

15. The social media based recommendation information providing apparatus of claim 14, wherein the one or more processors are further configured to:
determine whether a desired location request word is included in the message of the one of the users; and
search for the user location information as the corresponding information when the one or more processors determines that the location request word is included.

16. The social media based recommendation information providing apparatus of claim 14, wherein the one or more processors are further configured to:
determine whether the message of the one of the users is successively input more than a reference number of times in a reference time, and
search for the message notification method setting information as the corresponding information when the one or more processors determines that the message of the one of the users is successively input more than the reference number of times in the reference time.

17. The social media based recommendation information providing apparatus of claim 14, wherein the one or more processors are further configured to:
determine whether a same message as the message of the one of the users has been sent to more than a reference number of users; and
search for the phishing history information as the corresponding information when the one or more processors determines that the same message as the message of the one of the users is sent to more than the reference number of users.

18. The social media based recommendation information providing apparatus of claim 14, wherein the one or more processors are further configured to:
determine whether a profile request word is included in the message of the one of the users; and
search for the user profile information as the corresponding information when it is determined that the profile request word is included.

19. A non-transitory computer-readable recording medium storing a computer program, which when executed by a computer, configures the computer to perform the method of claim 1.
